(19) United States
(12) Patent Application Publication
(10) Pub. No.: US 2025/0279566 A1
(43) Pub. Date: Sep. 4, 2025

(54) COUPLER AND ELECTRONIC DEVICE COMPRISING SAME

(71) Applicants: Samsung Electronics Co., Ltd., Suwon-si (KR); SEOUL NATIONAL UNIVERSITY R&DB FOUNDATION, Seoul (KR)

(72) Inventors: Sungku YEO, Suwon-si (KR); Jungsuek OH, Seoul (KR); Minbeom KO, Suwon-si (KR); Sunryul KIM, Suwon-si (KR); Joonhong KIM, Suwon-si (KR); Taeyeong YOON, Seoul (KR); Chongmin LEE, Suwon-si (KR)

(21) Appl. No.: 19/210,766

(22) Filed: May 16, 2025

Related U.S. Application Data
(63) Continuation of application No. PCT/KR2023/018552, filed on Nov. 17, 2023.

(30) Foreign Application Priority Data
Nov. 18, 2022 (KR) 10-2022-0155242

(51) Int. Cl. H01P 5/18

(52) U.S. Cl. CPC H01P 5/185

(57) ABSTRACT

A coupler is provided. A coupler may comprise: a first layer including a plurality of first conductive segments; a second layer disposed to at least partially overlap the first layer and including a plurality of second conductive segments that are linearly symmetrical with the plurality of first conductive segments when projected onto the first layer; and a third layer including a plurality of third conductive segments overlapping two different second conductive segments from among the plurality of second conductive segments arranged in the second layer.

### CROSS-REFERENCE TO RELATED APPLICATIONS

This application is a continuation of International Application No. PCT/KR2023/018552 designating the United States, filed on Nov. 17, 2023, in the Korean Intellectual Property Receiving Office and claiming priority to Korean Patent Application No. 10-2022-0155242, filed on Nov. 18, 2022, in the Korean Intellectual Property Office, the disclosures of each of which are incorporated by reference herein in their entireties.

### BACKGROUND

### Field

The disclosure relates to, for example, a coupler and an electronic device including the same.

### Description of Related Art

An electronic device may communicate with a base station that provides a wireless communication network through communication components included in the electronic device. Recently, electronic devices have become smaller, thinner, and/or more integrated, and the use frequency of communication components included in the electronic devices is increasingly higher and narrower.

A power amplifier (PA) is provided at the transmitting end of a wireless communication circuit in the electronic device, and a capacitor may be provided as one of the components for amplifying a transmission signal in the PA. As one of the parameters indicating the quality of the capacitor, a Q factor may indicate the concentration rate of energy at resonance or the quality of energy storage. As the Q factor increases, a resonance amplitude (energy accumulation rate) increases at resonance, whereas as the Q factor decreases, the resonance amplitude decreases. Therefore, it may be generally considered that the performance of the capacitor is better as the Q factor is larger. However, since a capacitor, which is generally included as a part of a PA, has sensitive responsiveness to changes in the frequency band of an applied signal and basically has a low Q factor, there may be limitations in improving the performance of the PA using only this capacitor.

A coupler, which divides and/or combines signal power at a specific ratio, is known as a component for wireless communication in an electronic device. The coupler may be configured as a combination of two or more conductors (e.g., capacitors) and implemented in various shapes for desired optimal power transmission. Typically, as more conductors (e.g., capacitors) are arranged in the coupler, the design freedom increases, which may improve the performance of the coupler. However, when the coupler is configured by arranging multiple conductors (e.g., capacitors), a considerable amount of space inside the electronic device may be occupied, and thus it may be difficult to make the electronic device small, thin, and/or integrated. As a method of improving the performance of the PA, the coupler that may replace the capacitor may be considered.

The above information is presented as prior art simply to assist with an understanding of the disclosure. No determination has been made, and no assertion is made, as to whether any of the above might be applicable as prior art with regard to the disclosure.

### SUMMARY

According to an example embodiment of the disclosure, a coupler is provided. According to an example embodiment, the coupler may include: a first layer including a plurality of first conductive segments, a second layer arranged to overlap at least partially the first layer and including a plurality of second conductive segments line-symmetrical with the plurality of first conductive segments, when the second layer is projected onto the first layer, and a third layer including a plurality of third conductive segments arranged to overlap two different second conductive segments among the plurality of second conductive segments arranged on the second layer.

According to an example embodiment of the disclosure, a coupler is provided. According to an example embodiment, the coupler may include: a plurality of first conductive segments, a plurality of second conductive segments at least partially overlapping the plurality of first conductive segments, a first conductive via connecting the plurality of first conductive segments and the plurality of second conductive segments, a plurality of third conductive segments arranged to overlap two different second conductive segments among the plurality of second conductive segments, a second conductive via connecting the plurality of second conductive segments and the plurality of third conductive segments, a plurality of fourth conductive segments at least partially overlapping the plurality of third conductive segments, and a third conductive via connecting the plurality of third conductive segments and the plurality of fourth conductive segments.

### BRIEF DESCRIPTION OF THE DRAWINGS

The above or other aspects, features and/or advantages of certain embodiments of the present disclosure will be more apparent from the following detailed description taken in conjunction with the accompanying drawings, in which:

FIG. 1 is a perspective view illustrating a wafer and a coupler module including the wafer according to an embodiment;

FIG. 2 is a perspective view illustrating an example coupler according to an embodiment;

FIG. 3 is a diagram illustrating a front view of a first layer included in a coupler according to an embodiment;

FIG. 4 is a diagram illustrating front view of a second layer included in a coupler according to an embodiment;

FIG. 5 is a diagram illustrating a front view of a third layer included in a coupler according to an embodiment;

FIG. 6 is a diagram illustrating a front view of a fourth layer included in a coupler according to an embodiment;

FIG. 7 is an exploded perspective view illustrating a coupler according to an embodiment;

FIG. 8 is a cross-sectional view illustrating a coupler according to an embodiment;

FIG. 9 is an exploded perspective view illustrating a coupler according to an embodiment;

FIG. 10 is a circuit diagram illustrating an electronic component to which a coupler is applied according to an embodiment;

FIG. 11 is a graph illustrating efficiency (amplifier power efficiency (PAE)) and a graph illustrating output power Pout for input power Pin, according to Q factors of an electronic component including a capacitor;

FIG. 12 is a graph illustrating Q factors according to various frequency bands of an electronic component including a capacitor; and

FIG. 13 is a graph illustrating Q factors according to various frequency bands of an electronic component including a coupler according to an embodiment.

### DETAILED DESCRIPTION

As a method of improving the performance of a power amplifier, a coupler that may replace a capacitor may be considered. According to various embodiments of the disclosure, a coupler and/or a coupler module is provided, which may improve the performance (e.g., Q factor) of a power amplifier and an electronic device including the same by replacing a capacitor, while being compact enough to satisfy miniaturization, thinning, and/or integration requirements of an electronic device.

Various example embodiments of the disclosure will be described in greater detail below with reference to the attached drawings.

Embodiments of the disclosure are provided to more fully explain the disclosure to those skilled in the art, and the following example embodiments may be modified to various different forms, and the scope of the disclosure is not limited to the following embodiments. Rather, these example embodiments are provided to more faithfully and completely convey the idea of the disclosure to those skilled in the art.

In the drawings, the thickness or size of each layer may be exaggerated or reduced for convenience and clarity of description, and the same reference numerals in the drawings refer to the same elements. As used herein, the term “and/or” includes any and all combinations of one or more of the listed items. In the disclosure, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “first” and “second”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled to” or “connected to” another element (e.g., a second element), the element may be coupled with the other element directly (e.g., wiredly), wirelessly, or via a third element.

In the drawings, the dimensions of structures may be exaggerated, for clarity of the disclosure.

In the disclosure, the terms “first,” “second,” and so on may be used to describe various components, but the components should not be limited by the terms. The terms are used only to distinguish one component from another.

The terms used in the disclosure are used merely to describe example embodiments and are not intended to limit the disclosure. The singular expression includes the plural expression unless the context clearly indicates otherwise. In the application, the term “include” or “have” is intended to specify the presence of a feature, number, step, operation, component, part, or combination thereof described in the disclosure, but should be understood as not excluding the possibility of the presence or addition of one or more other features, numbers, steps, operations, components, parts, or combinations thereof.

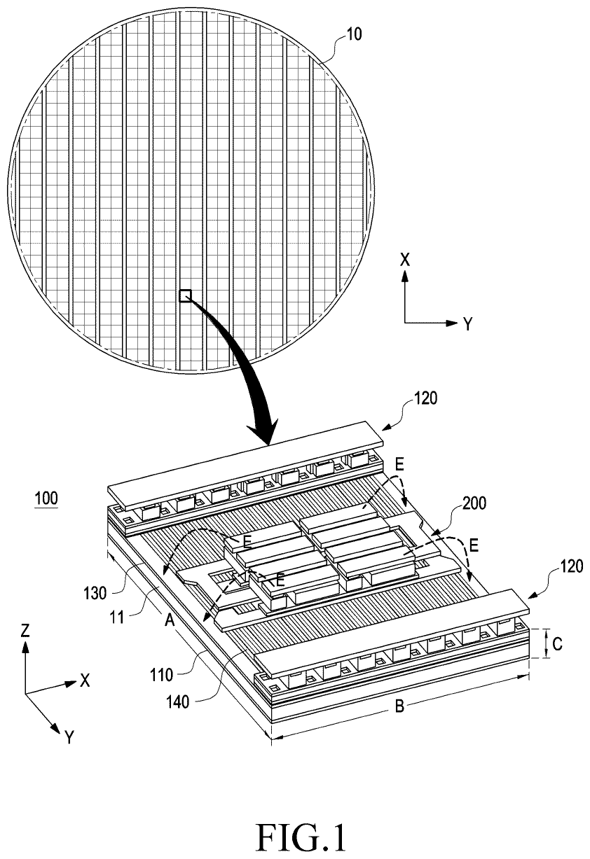

FIG. 1 is a perspective view illustrating a wafer and a coupler module including the wafer according to an embodiment.

In the following detailed description, a vertical width direction of a coupler module 100 and/or a coupler 200 included in the coupler module 100 may be defined as a ‘Y-axis direction’, a horizontal width direction thereof as an ‘X-axis direction’, and/or a height direction thereof as a ‘Z-axis direction’. In describing the directions, ‘negative/positive (−/+)’ may not be described. When ‘negative/positive (−/+)’ is not described, it may be interpreted as including both a + direction and a − direction, unless otherwise defined. That is, the ‘X-axis direction’ may be interpreted as including both a +X direction and a −X direction, and the ‘Y-axis direction’ may be interpreted as including both a +Y direction and a −Y direction. In describing the directions, ‘facing one of the three axes of the Cartesian coordinate system’ may include facing a direction parallel to the axis. This is based on the Cartesian coordinate system described in the drawings, for conciseness of description, and it should be noted that the description of such directions or components does not limit various embodiments of the disclosure. In the following embodiments of the coupler module 100 and/or the coupler 200 included in the coupler module 100, a “first direction” may refer, for example, to a direction parallel to the X-axis direction.

Referring to FIG. 1, a substrate 10 on which a plurality of semiconductor integrated circuits are arranged is illustrated.

The substrate 10 may include a semiconductor material such as silicon or germanium. In an example embodiment, the substrate 10 may be a single crystal silicon wafer. A plurality of semiconductor integrated circuits may be formed on the substrate 10 made of a single crystal silicon wafer. The plurality of semiconductor integrated circuits may all be a single type of components, but according to an embodiment, different types of components may be formed on the single crystal silicon wafer.

According to an embodiment, the coupler module 100 of the disclosure may be formed on at least some of the plurality of semiconductor integrated circuits formed on the single crystal silicon wafer. Herein, the term ‘module’ may refer, for example, to a single component and/or structure or a combination of multiple components and/or structures, for performing at least one or two functions. A module may be an integrally configured component or a minimum unit or part of the component that performs one or more functions. For example, according to an embodiment, the module may be implemented in the form of an application-specific integrated circuit (ASIC). Herein, the term ‘combination’ may include all types of combinations, such as fastening, assembly, and mounting of one component and another component.

Referring to FIG. 1, the coupler module 100 of the disclosure may be formed by combining the coupler 200 and components and/or structures around the coupler 200. A plurality of coupler modules 100 may be included in one substrate 10. The plurality of coupler modules 100 included in the substrate 10 may be individually or collectively cut. The coupler module 100 cut from the substrate 10 may be mounted on an electronic device (e.g., a portable terminal such as a smartphone) in the form illustrated in the drawing or through some additional process (e.g., ground connection) and used to implement at least one function (e.g., for the purpose of amplifying the capacitance of a power amplifier (PA) included in a communication module).

Referring to FIG. 1, the coupler module 100 may be formed in a vertical width ‘A’, a horizontal width ‘B’, and a height ‘C’, and the vertical width ‘A’, the horizontal width ‘B’, and the height ‘C’ may have dimensions in a range of tens to hundreds of μm. As will be described in greater detail below, although the coupler 200 included in the coupler module 100 may be configured with a combination of a plurality of conductive segments and thus have high coupler performance, the size of the coupler module 100 may be configured in micro units, thereby achieving the purpose of miniaturization, thinning, and/or integration of an electronic device.

The coupler 200 may be a component that uses coupling, which is a phenomenon in which alternating current (AC) signal energy is mutually transmitted electromagnetically between independent spaces or lines. The coupler 200 may be disposed on the substrate 10 made of a silicon wafer. For example, as illustrated in the drawing, the coupler 200 may be disposed on a die 11 of the substrate 10 made of a silicon wafer. According to an embodiment, the coupler 200 may be grounded to a ground 110 disposed on a rear surface of the die 11. The ground 110 may be referred to as a ‘first ground 110’ to distinguish it from a second ground 120 described below.

According to an embodiment, the coupler module 100 may be formed such that, while the coupler 200 is disposed on the die 11, the separate second ground 120 is disposed together on the die 11 and at least partially surrounds the coupler 200. According to an embodiment, the coupler module 100 may be configured in a form in which the coupler 200 and the second ground 120 are disposed side by side in the first direction. The second ground 120 may include at least one conductor, and its shape and size may be set in various ways. For example, the second ground 120 illustrated in FIG. 1 may be formed to have, but is necessarily limited to, a length corresponding to the length of the coupler 200 and a height corresponding to the height of the coupler 200. In addition, it should be noted that the coupler module 100 may also be applied in a form in which only the coupler 200 is disposed on the die 11 without the second ground 120.

According to an embodiment, at least one dielectric layer 130 may be provided between the coupler 200 and the die 11. The number and type of dielectric layers 130 may vary depending on an embodiment.

According to an embodiment, the coupler module 100 may further include a metal member 140 disposed on a top surface of the die 11. As the coupler 200 is formed on the die 11 of the substrate 10 made of a silicon wafer, the performance of the coupler 200 may be deteriorated by an electric field (E-field (E)) that may be formed between the coupler 200 and the die 11 made of silicon, which may cause the deterioration of the ‘Q factor’ of the electronic device described below. For example, in addition to the first ground 110 and the dielectric layer 130, a conductive line (e.g., a signal line) that is not shown in the drawing may be formed on the die 11, which may decrease the Q factor of the electronic device. According to an embodiment of the disclosure, the metal member 140 may be further included between the coupler 200 and the die 11 to prevent and/or reduce the decrease of the Q factor. For example, although the metal member 140 may be provided in the form of a wide flat plate, a form in which a plurality of thin and long rod-shaped metal members 140 are arranged side by side may also be applied, as illustrated in the drawing. The shape of the metal member 140 may be designed in various ways depending on an embodiment.

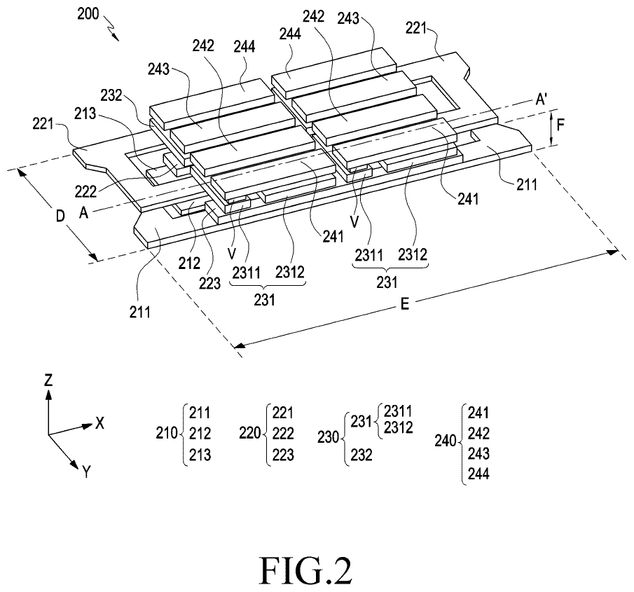

FIG. 2 is a perspective view illustrating an example coupler according to an embodiment.

Referring to FIGS. 2, 3 and 4, the coupler 200 of the disclosure may be formed in a structure in which multilayer conductive plates are stacked. For example, the coupler 200 may include a first layer 210, a second layer 220 formed on the first layer 210, and a third layer 230 formed on the second layer 220. According to an embodiment, the coupler 200 may further include a fourth layer 240 formed on the third layer 230, so that the first layer 210, the second layer 220, the third layer 230, and the fourth layer 240 may be stacked. In the following embodiment, a description is given mainly in the context of the stack of the first layer 210, the second layer 220, the third layer 230, and the fourth layer 240, but it should be noted that the fourth layer 240 may be omitted depending on an embodiment.

Referring to FIG. 2, the coupler 200 may be formed in a vertical width ‘D’, a horizontal width ‘E’, and a height ‘F’, and the vertical width ‘D’, the horizontal width ‘E’, and the height ‘F’ may have dimensions of approximately several μm to several tens of μm.

According to an embodiment, each of the first layer 210, the second layer 220, the third layer 230, and the fourth layer 240 may include at least one conductive portion. For example, the first layer 210 may include a plurality of first conductive segments 211, 212, and 213, and the second layer 220 may include a plurality of second conductive segments 221, 222, and 223. The third layer 230 may include a plurality of third conductive segments 231 and 232. In addition, the fourth layer 240 may include a plurality of fourth conductive segments 241, 242, 243, and 244.

A conductive portion of the second layer 220 may be disposed to overlap at least partially on a conductive portion of the first layer 210. That is, the plurality of second conductive segments 221, 222, and 223 may be arranged to at least partially overlap the plurality of first conductive segments 211, 212, and 213. According to an embodiment, when the second layer 220 is projected onto the first layer along the height direction (Z-axis direction) of the coupler 200, the plurality of second conductive segments 221, 222, and 223 may be configured to be line-symmetrical with the plurality of first conductive segments.

The third layer 230 may include the plurality of third conductive segments 231 and 232 arranged to overlap two different second conductive segments among the plurality of second conductive segments 221, 222, and 223 arranged in the second layer 220. For example, the plurality of third conductive segments 231 and 232 may include a plurality of third conductive segments 231 and 232 arranged to overlap two different second conductive segments indicated by reference numerals 221 and 222 among the plurality of second conductive segments 221, 222, and 223, and may also include a plurality of third conductive segments 231 and 232 arranged to overlap two different second conductive segments indicated by reference numerals 221 and 223. Any one 231 of the plurality of third conductive segments 231 and 232 may include third sub-conductive segments indicated by reference numerals 2311 and 2312.

Further, the fourth layer 240 may include the plurality of fourth conductive segments 241, 242, 243, and 244 arranged to overlap two different third conductive segments among the plurality of third conductive segments 231 and 232 arranged in the third layer 230. For example, any one 241 of the plurality of fourth conductive segments may be disposed to overlap two different third conductive segments, for example, the third sub-conductive segments indicated by reference numerals 2311 and 2312.

According to an embodiment, the coupler 200 including the first layer 210, the second layer 220, the third layer 230, and the fourth layer 240 may have at least one conductive via v formed between every two layers to implement an electrical connection for each layer.

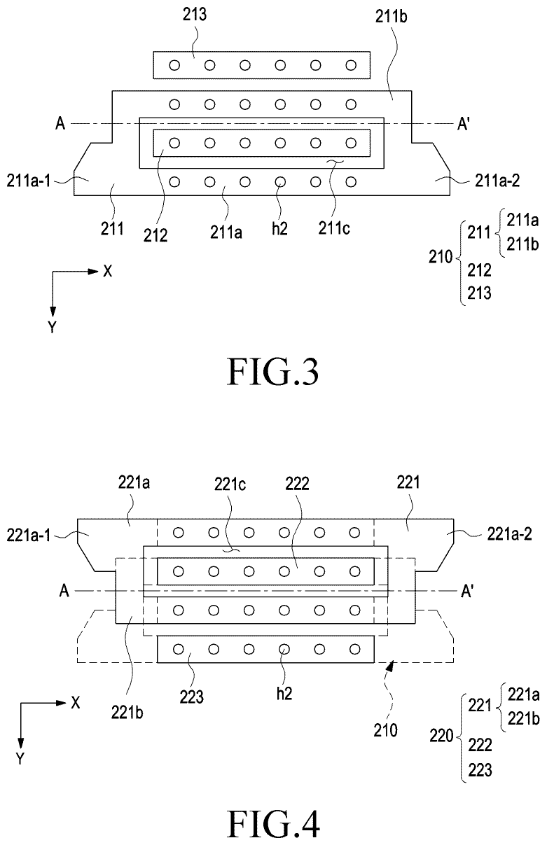

Each component of the first layer 210, the second layer 220, the third layer 230, and the fourth layer 240 will be described below in more detail with reference to FIGS. 3 to 6.

FIG. 3 is a diagram illustrating a front view of a first layer included in a coupler according to an embodiment.

Referring to FIG. 3, the first layer 210 may include, as the first conductive segments, a first portion 211a elongated along the first direction (e.g., X-axis direction) and a second portion 211b branched from the first portion 211a and elongated along the first direction (e.g., X-axis direction). According to an embodiment, the first portion 211a and the second portion 211b may be connected to each other to form a loop shape. According to an embodiment, the first portion 211a and the second portion 211b may be portions through which a signal (e.g., RF signal) is transmitted. For example, one end 211a-1 of the first portion 211a may be an input terminal (e.g., RF input) of a signal, and the other end 211a-2 of the first portion 211a may be an output terminal (e.g., RF output) of the signal. A signal input through the one end 211a-1 of the first portion 211a may pass through the first portion 211a and the second portion 211b and be output through the other end 211a-2 of the first portion 211a.

According to an embodiment, the first layer 210 may include a first opening 211c surrounded by the first portion 211a and the second portion 211b. The first opening 211c is a portion where a conductive portion is fill-cut, may be filled with an insulator according to an embodiment, and may act as an element for determining the dielectric constant of the coupler of the disclosure.

According to an embodiment, the first layer 210 may include a third portion 212 disposed between the first portion 211a and the second portion 211b and elongated along the first direction (e.g., X-axis direction). The first layer 210 may include a fourth portion 213 disposed spaced apart from the second portion 211b and elongated along the first direction (e.g., X-axis direction), additionally or alternatively to the third portion 212.

In the first layer 210, at least one via hole h1 may be formed in the first portion 211a, the second portion 211b, the third portion 212, and/or the fourth portion 213. The first layer 210 may be electrically connected to an adjacent layer (e.g., the second layer 220) through a conductive via (e.g., a first conductive via v1 described below) formed in the via hole h1.

FIG. 4 is a diagram illustrating a front view of a second layer included in a coupler according to an embodiment.

The second layer 220 may be disposed to overlap at least partially on the first layer 210, and include the plurality of second conductive segments 221, 222, and 223 that are symmetrical with the plurality of first conductive segments 211, 212, and 213, when projected onto the first layer 210. In FIG. 4, to help understand the arrangement of components, the second layer 220 may be drawn in a solid line, and the first layer 210 described above with reference to FIG. 3 may be drawn in a dotted line. Referring to FIG. 4, assuming that the first layer 210 and the second layer 220 are disposed on an imaginary plane parallel to an x-y plane, it may be identified that they have a shape in which they are line-symmetrical with respect to line A-A′.

The second layer 210 may include, as the second conductive segments, a fifth portion 221a elongated along the first direction (e.g., X-axis direction) and a sixth portion 221b that is branched from the fifth portion 221a and elongated along the first direction (e.g., X-axis direction). According to an embodiment, the fifth portion 221a and the sixth portion 221b may be connected to each other to form a loop shape. According to an embodiment, the fifth portion 221a and the sixth portion 221b may be portions through which a signal (e.g., RF signal) is transmitted, and for example, one end 221a-1 of the fifth portion 221a may be an input terminal of the signal, and the other end 221a-2 of the fifth portion 221a may be an output terminal of the signal. A signal input through the one end 221a-1 of the fifth portion 221a may pass through the fifth portion 221a and the sixth portion 221b and be output through the other end 221a-2 of the fifth portion 221a.

According to an embodiment, the second layer 220 may include a second opening 221c surrounded by the fifth portion 221a and the sixth portion 221b. The second opening 221c may be filled with an insulator according to an embodiment and act as an element for determining the dielectric constant of the coupler of the disclosure.

According to an embodiment, the second layer 220 may include a seventh portion 222 which is disposed between the fifth portion 221a and the sixth portion 221b and elongated along the first direction (e.g., X-axis direction). Further, the second layer 220 may include an eighth portion 223 that is disposed spaced apart from the sixth portion 221b and elongated along the first direction (e.g., X-axis direction), additionally or alternatively to the seventh portion 222.

In the second layer 220, at least one via hole h2 may be formed in the fifth portion 221a, the sixth portion 221b, the seventh portion 222, and/or the eighth portion 223. The second layer 220 may be electrically connected to an adjacent layer (e.g., the first layer 220) through a conductive via (e.g., the first conductive via v1 described below) formed in the via hole h2. In addition, the second layer 220 may be electrically connected to another adjacent layer (e.g., the third layer 230) through another conductive via (e.g., a second conductive via v2) described later formed in the via hole h2.

According to an embodiment, the second conductive segments included in the second layer 220 may be formed to correspond in length and width to the first conductive segments included in the first layer 210. Referring to FIGS. 3 and 4 together, the first conductive segments of the first layer 210 and the second conductive segments of the second layer 220 may have a structure in which they are symmetrical with respect to the imaginary line A-A′. The first conductive segments of the first layer 210 and the second conductive segments of the second layer 220 may have a shape in which they are symmetrical with respect to the imaginary line A-A′ and may be electrically connected through a conductive via (e.g., the first conductive via v1) described below. According to an embodiment, the fifth portion 221a of the second layer 220 may overlap the fourth portion 213 of the first layer 210, and the fifth portion 221a and the fourth portion 213 may be electrically connected to each other through the first conductive via v1. In addition, the sixth portion 221b of the second layer 220 may overlap the third portion 212 of the first layer 210, and the sixth portion 221b and the third portion 212 may be electrically connected to each other through the first conductive via v1. In addition, the seventh portion 222 of the second layer 220 may overlap the second portion 211b of the first layer 210, and the seventh portion 222 and the second portion 211b may be electrically connected to each other through the first conductive via v1. In addition, the eighth portion 223 of the second layer 220 may overlap the first portion 211a of the first layer 210, and the eighth portion 223 and the first portion 211a may be electrically connected to each other through the first conductive via v1.

According to an embodiment, the fifth portion 221a and the sixth portion 221b of the second layer 220, and the third portion 212 and the fourth portion 213 of the first layer 210 may form one conductive segment group (a first conductive segment group) in which they are electrically connected to each other through the first conductive via v1. In addition, the seventh portion 222 and the eighth portion 223 of the second layer 220 and the first portion 211a and the second portion 211b of the first layer 210 may form another conductive segment group (a second conductive segment group) in which they are electrically connected to each other through the first conductive via v1.

The conductive segments (the first conductive segment group) including the fifth portion 221a and the sixth portion 221b of the second layer 220, and the third portion 212 and the fourth portion 213 of the first layer 210, and the conductive segments (the second conductive segment group) including the seventh portion 222 and the eighth portion 223 of the second layer 220, and the first portion 211a and the second portion 211b of the first layer 210 may be coupled to each other and formed to be line-symmetrical with respect to line A-A′, thereby forming a coupling signal in a lateral direction (e.g., lateral) of the coupler 200.

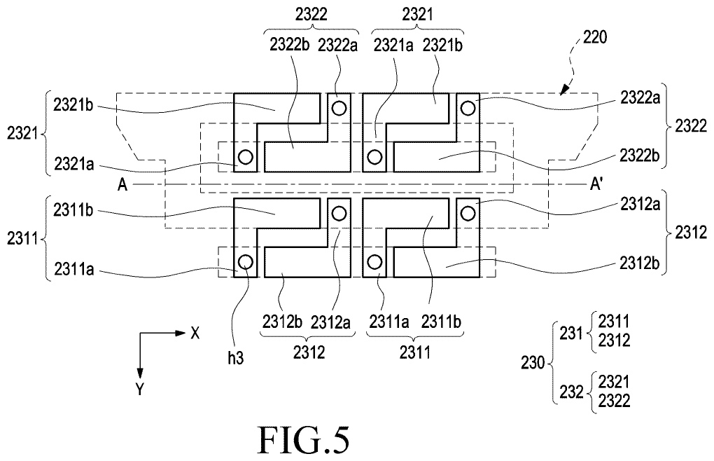

FIG. 5 is a diagram illustrating a front view of a third layer included in a coupler according to an embodiment. In FIG. 5, to help understand the arrangement of components, the third layer 230 may be drawn in a solid line, and the second layer 220 described above in FIG. 4 may be drawn in a dotted line.

Referring to FIG. 5, the third layer 230 may include, as the plurality of third conductive segments 231 and 232, ninth portions 2311a, 2312a, 2321a, and 2322a extending in a second direction (e.g., Y-axis direction) perpendicular to the first direction (e.g., X-axis direction), and tenth portions 2311b, 2312b, 2321b, and 2322b extending in the first direction. The plurality of third conductive segments 231 and 232 of the third layer 230 may be formed to have an approximate “L” shape. The third conductive segments 231 and 232 may have a third conductive segment indicated by reference numeral 231 disposed on one side of the imaginary line A-A′ and a third conductive segment indicated by reference numeral 232 disposed on the other side of the imaginary line A-A′, and each of the third conductive segments 231 and 232 may include third sub-conductive segments 2311 and 2312 having the same structure. For example, the third conductive segment 231 disposed below the imaginary line A-A′ may have two third sub-conductive segments indicated by reference numerals 2311 and 2312 disposed in a shape in which they are point-symmetrical with each other. The third sub-conductive segments 2311 and 2312 may include the ninth portion 2311a extending in the second direction (e.g., Y-axis direction) and the tenth portion 2311b extending in the first direction (e.g., X-axis direction).

According to an embodiment, the third conductive segments included in the third layer 230 may be formed to correspond in length and width to the second conductive segments included in the second layer 220. Referring to FIGS. 4 and 5 together, one third conductive segment 231 may be formed such that the ninth portion 2311a extending in the second direction (e.g., Y-axis direction) overlaps the eighth portion 223 and the sixth portion 221b of the second conductive segments, and the tenth portion 2311b extending in the first direction (e.g., X-axis direction) overlaps the sixth portion 221b in parallel. Another third conductive segment 232 may be formed such that the ninth portion 2312a extending in the second direction (e.g., Y-axis direction) overlaps the sixth portion 221b and the eighth portion 223 of the second conductive segments, and the tenth portion 2312b extending in the first direction (e.g., X-axis direction) overlaps the eighth portion 223 in parallel.

The third layer 230 may have at least one via hole h3 formed in the ninth portions 2311a, 2312a, 2321a, and 2322a among the ninth portions 2311a, 2312a, 2321a, and 2322a and the tenth portions 2311b, 2312b, 2321b, and 2322b. The third layer 230 may be electrically connected to an adjacent layer (e.g., the second layer 220) through a conductive via (e.g., the second conductive via v2 described in greater detail below) formed in the via hole h3. In addition, the third layer 230 may be electrically connected to another adjacent layer (e.g., the fourth layer 240) through another conductive via (e.g., a third conductive via v3 described in greater detail below) formed in the via hole h3. The third sub-conductive segments 2311 and 2312 may have a structure in which a via hole is formed in the ninth portion 2311a extending in the second direction (e.g., Y-axis direction) and the third sub-conductive segments 2311 and 2312 are connected to a conductive portion of another upper/lower layer through this.

According to an embodiment, the ninth portion indicated by reference numeral 2311a in the third layer 230 may overlap the eighth portion 223 of the second layer 220, and the ninth portion indicated by reference numeral 2311a and the eighth portion 223 may be electrically connected to each other through the second conductive via v2. In addition, the ninth portion indicated by reference numeral 2312a in the third layer 230 may overlap the sixth portion 221b of the second layer 220, and the ninth portion indicated by reference numeral 2312a and the sixth portion 221b may be electrically connected to each other through the second conductive via v2. In addition, the ninth portion indicated by reference numeral 2321a in the third layer 230 may overlap the seventh portion 222 of the second layer 220, and the ninth portion indicated by reference numeral 2321a and the seventh portion 222 may be electrically connected to each other through the second conductive via v2. In addition, the ninth portion indicated by reference numeral 2322a in the third layer 230 may overlap the fifth portion 221b of the second layer 22, and the ninth portion indicated by reference numeral 2322a and the fifth portion 221a may be electrically connected to each other through the second conductive via v2.

In such a structure, the third conductive segments of the third layer 230 and the second conductive segments of the second layer 220 may form coupling signals in the lateral direction (e.g., lateral) and the vertical direction (e.g., vertical) of the coupler 200.

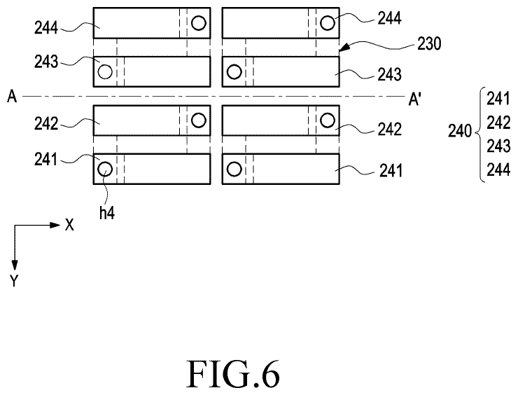

FIG. 6 is a diagram illustrating a front view of a fourth layer included in a coupler according to an embodiment. In FIG. 6, the fourth layer 240 may be drawn in a solid line, and the third layer 230 described above with reference to FIG. 5 may be drawn in a dotted line, to help understand the arrangement of components.

Referring to FIG. 6, the fourth layer 240 may include the plurality of fourth conductive segments 241, 242, 243, and 244 arranged so as to overlap at least partially with the plurality of third conductive segments 231 and 232 of the third layer 230. According to an embodiment, at least one of the fourth conductive segments 241, 242, 243, and 244 may be disposed to overlap at least two third conductive segments 231 and 232 among the plurality of third conductive segments. According to an embodiment, the fourth layer 240 may include, as the plurality of fourth conductive segments 241, 242, 243, 244, eleventh portions 241 and 243 and twelfth portions 242 and 244 extending in the first direction (e.g., X-axis direction). According to an embodiment, the fourth conductive segments included in the fourth layer 240 may be formed to correspond in length and width to the third conductive segments included in the third layer 230. Referring to FIGS. 5 and 6 together, one fourth conductive segment 241 may extend in the first direction (e.g., X-axis direction) and may be formed across the two different third sub-conductive segments 2311 and 2312.

At least one via hole h4 may be formed in the fourth layer 240. The fourth layer 240 may be electrically connected to an adjacent layer (e.g., the third layer 230) through a conductive via (e.g., the third conductive via v3 described in greater detail below) formed in the via hole h4. Each of the plurality of fourth conductive segments 241, 242, 243, and 244 included in the fourth layer 240 may include one via hole h4, and the via holes h4 of adjacent conductive segments may be formed to be opposite to each other in position. For example, when a via hole h4 is formed at one end of one fourth conductive segment (e.g., the eleventh portion 241 or 243), a via hole h4 may be formed at the opposite end of another fourth conductive segment (e.g., the twelfth portion 242 or 244) adjacent thereto.

According to an embodiment, the eleventh portion indicated by reference numeral in the fourth layer 240 may overlap the ninth portion indicated by reference numeral 2311a and the tenth portion indicated by reference numeral 2312b in the third layer 230. In addition, the eleventh portion indicated by reference numeral 241 in the fourth layer 240 and the ninth portion indicated by reference numeral 2311a may be electrically connected to each other through the third conductive via v3. In addition, the twelfth portion indicated by reference numeral 242 in the fourth layer 240 may overlap the tenth portion indicated by reference numeral 2311b and the ninth portion indicated by reference numeral 2312a in the third layer 230. The twelfth portion indicated by reference numeral 242 in the fourth layer 240 and the ninth portion indicated by reference numeral 2312a may be electrically connected to each other through the third conductive via v3. The eleventh portion indicated by reference numeral 243 in the fourth layer 240 may overlap the ninth portion indicated by reference numeral 2321a and the tenth portion indicated by reference numeral 2322b in the third layer 230. The eleventh portion indicated by reference numeral 243 in the fourth layer 240 and the ninth portion indicated by reference numeral 2321a may be electrically connected to each other through the third conductive via v3. In addition, the twelfth portion indicated by reference numeral 244 in the fourth layer 240 may overlap the tenth portion indicated by reference numeral 2312b and the ninth portion indicated by reference numeral 2322a in the third layer 230. The twelfth portion indicated by reference numeral 244 in the fourth layer 240 and the ninth portion indicated by reference numeral 2322a may be electrically connected to each other through the third conductive via v3.

In such a structure, the fourth conductive segments of the fourth layer 240 and the third conductive segments of the third layer 230 may form a coupling signal in the lateral direction (e.g., lateral) and the vertical direction (e.g., vertical) of the coupler 200.

When the fourth layer 240 is projected onto the third layer 230 in the height direction of the coupler 200, the via hole h4 of the fourth layer 240 may be formed at a position corresponding to the position of the via hole h3 of the third layer 230.

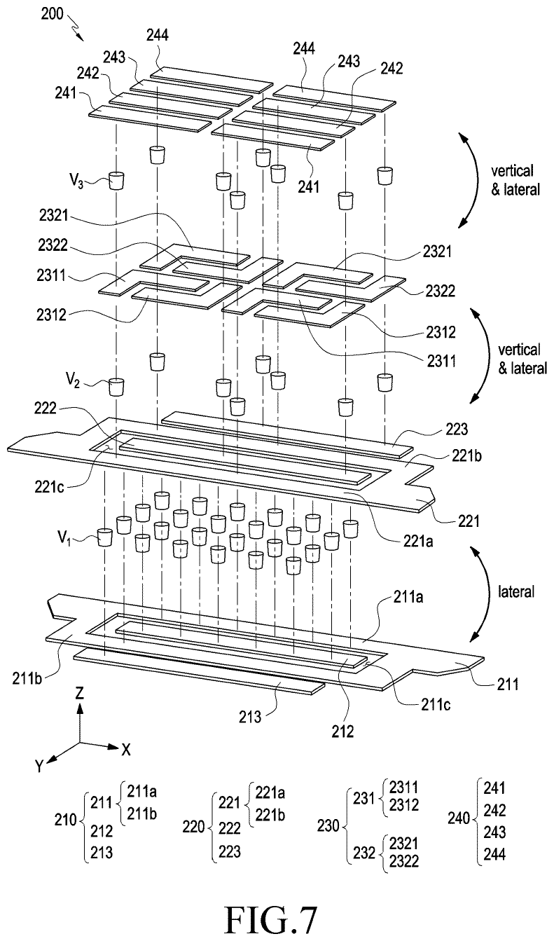

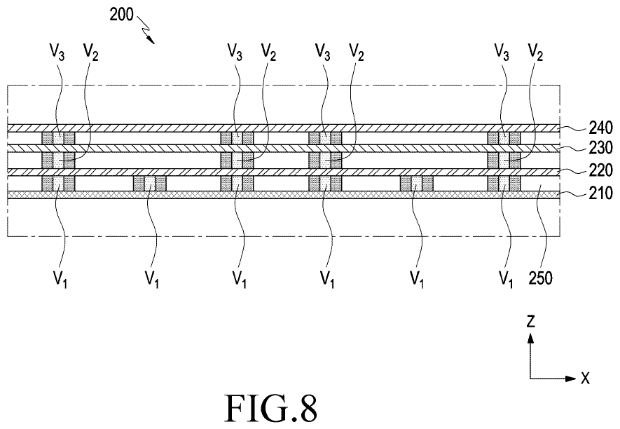

The arrangement relationship of the components in FIGS. 3 to 6 will be described in more detail below with reference to the coupler 200 illustrated in FIGS. 7 and 8.

FIG. 7 is an exploded perspective view illustrating a coupler according to an embodiment. FIG. 8 is a cross-sectional view illustrating a coupler according to an embodiment.

Referring to FIGS. 7 and 8 together, the conductive segments of the respective layers (the first layer 210, the second layer 220, the third layer 230, and the fourth layer 240) included in the coupler 200 may be implemented with widths and lengths that substantially correspond to each other. The conductive segments of the respective layers (the first layer 210, the second layer 220, the third layer 230, and the fourth layer 240) included in the coupler 200 may be formed to have different thicknesses (or heights) depending on an embodiment. For example, although the third layer 230 is shown as being thicker than the other layers in the coupler module 100 included in the substrate 10 in FIG. 1, this is only because the third layer 230 is formed relatively thick to meet specifications required in a wafer manufacturing process, and does not limit the disclosure.

Referring to FIG. 7, the plurality of first conductive segments 211, 212, and 213 of the first layer 210 have substantially the same structure as the plurality of second conductive segments 221, 222, and 223 of the second layer 220, but the segments are depicted as facing in opposite directions along the vertical width direction (e.g., Y-axis direction) of the coupler 200. According to an embodiment, the first portion 211a of the first layer 210 may overlap the eighth portion 223 of the second layer 220, the second portion 211b of the first layer 210 may overlap the seventh portion 222 of the second layer 220, the third portion 212 of the first layer 210 may overlap the sixth portion 221b of the second layer 220, and the fourth portion 213 of the first layer 210 may overlap the fifth portion 221a of the second layer 220.

Each of the plurality of third conductive segments 231 and 232 of the third layer 230 may include the two third sub-conductive segments 2311 and 231 or 22321 and 2322 having the same ‘7’ shape, and these third sub-conductive segments 2311 and 2312 or 2321 and 2322 may be arranged in a form in which the ‘7’ shapes are interlocked with each other on a plane (e.g., a virtual plane parallel to the XY plane). In this state, each of the plurality of third conductive segments 231 and 232 of the third layer 230 may be disposed to overlap at least two second conductive segments that are not electrically connected among the plurality of second conductive segments 221, 222, and 223 of the second layer 220.

Each of the plurality of fourth conductive segments 241, 242, 243, and 244 of the fourth layer 240 may be formed in a thin rod shape, for example, in a shape similar to the second portion 212 and the third portion 213 of the first layer 210, and the fifth portion 222 and the sixth portion 223 of the second layer 220, and disposed to overlap at least two third conductive segments that are not electrically connected.

The plurality of first conductive segments 211, 212, and 213 of the first layer 210 and the plurality of second conductive segments 221, 222, and 223 of the second layer may be connected through a plurality of first conductive vias v1, and the plurality of second conductive segments 221, 222, and 223 of the second layer 220 may be connected to the plurality of third conductive segments 231 and 232 of the third layer through a plurality of second conductive vias v2. Further, the plurality of third conductive segments 231 and 232 of the third layer 230 and the plurality of fourth conductive segments 241, 242, 243, and 244 of the fourth layer may be connected to each other through a plurality of third conductive vias v3.

According to an embodiment, the twelfth portions 242 and 244 of the fourth layer 240, the ninth portion indicated by reference numeral 2312a and the ninth portion indicated by reference numeral 2322a in the third layer 230, the fifth portion 221a and the sixth portion 221b in the second layer 220, and the third portion 212 and the fourth portion 213 in the first layer 210 may form one electrically connected conductive segment group (the first conductive segment group). Further, the eleventh portions 241 and 243 in the fourth layer 240, the ninth portion indicated by reference numeral 2311a and the ninth portion indicated by reference numeral 2321a in the third layer 230, the seventh portion 222 and the eighth portion 223 in the second layer 220, and the first portion 211a and the second portion 211b in the first layer 210 may form another electrically connected conductive segment group (the second conductive segment group).

In this arrangement, the coupler 200 may generate a lateral-direction coupling signal between the first layer 210 and the second layer 220, and may generate a lateral-direction coupling signal and a vertical-direction coupling signal between the second layer 220 and the third layer 230. Further, the coupler 200 may generate a lateral-direction coupling signal and a vertical-direction coupling signal between the third layer 230 and the fourth layer 240.

Referring to FIG. 8, the coupler 200 according to an embodiment may have a dielectric 250 formed on a layer with first conductive vias v1 formed therein, a layer with second conductive vias v2, and a layer with third conductive vias v3 formed therein.

The coupler 200 may be formed such that the first layer 210, the second layer 220, the third layer 230, and the fourth layer 240 are formed adjacent to each other, but spaced apart from each other by a predetermined distance, without being directly stacked, and various insulators (or dielectrics) may be disposed in a space between every two layers.

Regarding the number of layers forming the coupler 200, the coupler 200 of the disclosure is not limited to what is illustrated in the drawings, and may be designated to have various numbers of layers in consideration of various specifications of the substrate 10, a dielectric constant, and an effective space inside the electronic device. For example, although not shown in the drawings, more layers including a fifth layer may be included to enhance the performance of the coupler.

According to various embodiments of the disclosure, the coupler 230 having a new structure with high coupling efficiency and directivity may be provided. Further, as a space occupied by a conventional coupler in an electronic device may be reduced, and thus elements (e.g., a conductive plate, an RF signal transmission line, and a conductive line) replacing conventional passive elements may be designed more freely, a coupler capable of covering a wide band may be provided.

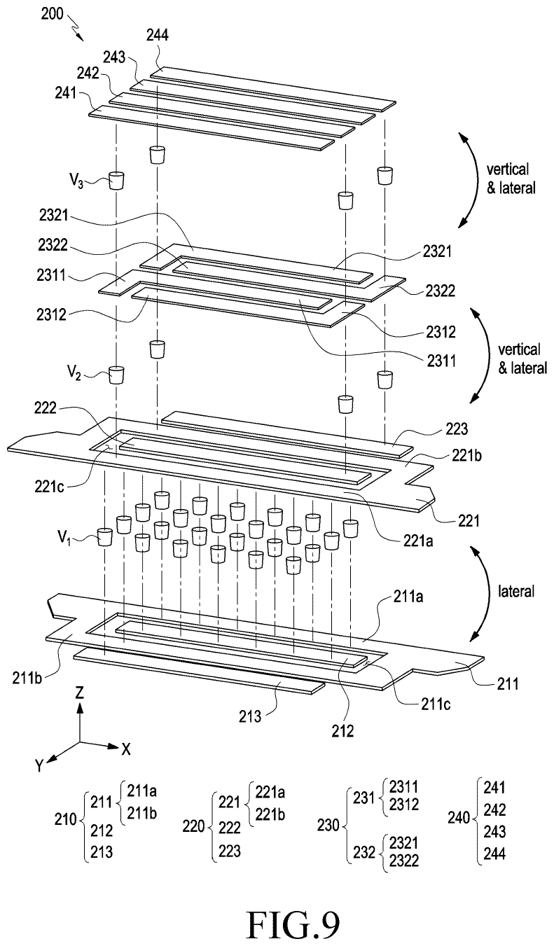

FIG. 9 is an exploded perspective view illustrating a coupler according to an embodiment. In FIGS. 1 to 8, the third conductive segments 231 and 232 of the third layer 230 and the fourth conductive segments 241, 242, 243, and 244 of the fourth layer 240 have a structure in which conductive segments of the same structure are repeatedly arranged in the first direction (e.g., X-axis direction) in order to secure high coupling efficiency. For example, in FIGS. 1 to 8, two sets of third conductive segments 231 and 232 of the same structure and two sets of fourth conductive segments 241, 242, 243, and 244 of the same structure are shown as arranged in the first direction (e.g., X-axis direction).

Referring to FIG. 9, the components of the third conductive segments 231 and 232 of the third layer 230 and the fourth conductive segments 241, 242, 243, and 244 of the fourth layer 240 are configured in a form that extends longer in the first direction (e.g., X-axis direction), and are configured as a single set, without being divided into two sets.

The coupler 200 may include a single set of third conductive segments 231 and 232 and fourth conductive segments 241, 242, 243, and 244, as illustrated in FIG. 9, or may include a plurality of sets of third conductive segments 231 and 232 and fourth conductive segments 241, 242, 243, and 244, as illustrated in FIGS. 1 to 8. These different embodiments of the coupler 200 may be applied in various ways as needed. Depending on an embodiment, more sets of third conductive segments 231 and 232 and fourth conductive segments 241, 242, 243, and 244 may be included.

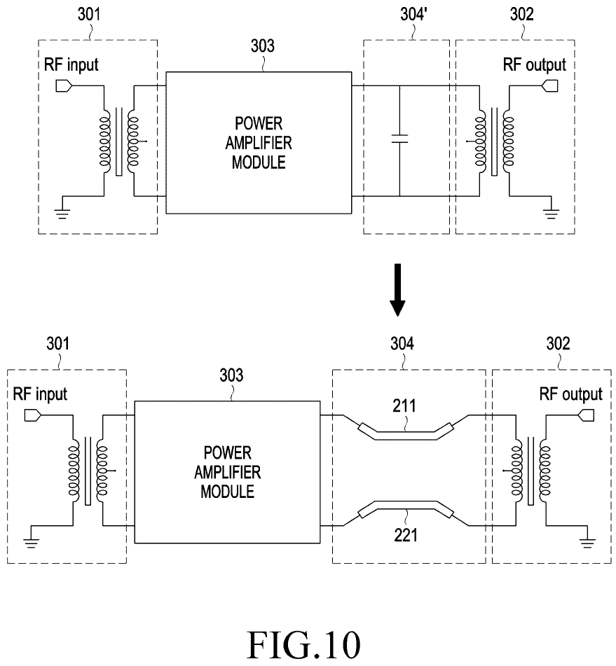

FIG. 10 is a circuit diagram illustrating an electronic component to which a coupler is applied according to an embodiment.

An electronic device including the coupler 200 of the disclosure may be any one of various types. The electronic device may include, for example, a portable communication device (e.g., a smartphone), a computer device, a portable multimedia device, a portable medical device, a camera, a wearable device, or a home appliance. The electronic device according to an embodiment of the disclosure is not limited to the above devices.

The coupler 200 of the disclosure may be applied to various electronic components. The electronic components may include an antenna and a wireless communication circuit.

Referring to FIG. 10, a wireless communication circuit of the disclosure may include an RF in line 301 and an RF out line 302. The wireless communication circuit may further include a power amplifier module 303. A coupler 304 (e.g., the coupler 200 of FIGS. 1 to 9) of the disclosure may be a component provided to secure a predetermined capacitance by replacing a capacitor 304′, which is a conventional passive component that may be located between the RF in line 301 and the RF out line 302.

According to various embodiments of the disclosure, the power amplifier module 303 may include a power amplifier or a low-noise amplifier. In an embodiment, the power amplifier may amplify an RF signal (e.g., Tx signal) received from a transceiver (not shown) and transmit it to a front-end module (not shown). According to an embodiment, the low-noise amplifier may amplify an RF signal (e.g., Rx signal) received from at least one antenna (not shown) through the front-end module, while minimizing and/or reducing noise, and transmit it to the transceiver. According to an embodiment, the amplification factor of the power amplifier or the low-noise amplifier may be determined by the magnitude of its energy source (e.g., voltage or current). In another example, the amplification factor may be changed by adjusting the magnitude of power (voltage or current) by a processor included in an electronic device.

Referring to FIG. 10, as a component included in the coupler 304, two conductors that may be coupled to each other may be included. For example, the two conductors illustrated in FIG. 10 may correspond to the first conductive segment indicated by reference numeral 211 and the second conductive segment indicated by reference numeral 221, respectively in the coupler 200 of FIGS. 1 to 9. The other conductive segments included in the coupler 200 of FIGS. 1 to 9 may be omitted for convenience. According to an embodiment, a signal (e.g., RF signal) input through the power amplifier module 303 may be output to the RF out line 302 through the first conductive segment indicated by reference numeral 211 and the second conductive segment indicated by reference numeral 221. According to an embodiment, the coupler 304 may be electromagnetically connected to the RF signal transmitted along the RF in/out line 301 during power amplification in the power amplifier module 303 to generate a coupling signal.

According to an embodiment of the disclosure, load impedance between at least one antenna (not shown) and the coupler 304 may have a predetermined difference from characteristic impedance of the coupler 304. According to various embodiments of the disclosure, although not shown in the drawing, an impedance tuning circuit (matching circuit) may be additionally provided to adjust the load impedance to be as close as possible to the characteristic impedance.

According to an embodiment of the disclosure, the processor may include at least one of a central processing unit, an application processor, or a communication processor (CP). The processor may perform, for example, computation or data processing related to control and/or communication of at least one other component of the electronic device. The processor may be electrically connected to other components (e.g., the transceiver (not shown), the power amplifier module 303, and/or the coupler 304) and control them, and may perform processing and computation of various data.

According to various embodiments of the disclosure, memory may be operatively connected to the processor. The memory may store instructions that, when executed, enable the processor to be electrically connect to other components (e.g., the transceiver (not shown), the power amplifier module 303, and/or the coupler 304) and control them, and perform processing and computation of various data. According to an embodiment, the memory may store compensation values for adjusting the load impedance to be as close as possible to the characteristic impedance.

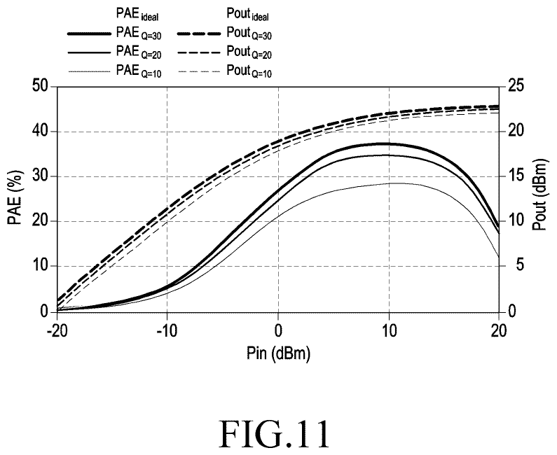

FIG. 11 is a graph illustrating efficiency (power amplifier efficiency (PAE)) for input power Pin and a graph illustrating output power Pout for input power Pin, according to Q factors for an electronic component including a capacitor. The graph illustrating output power Pout for input power Pin in FIG. 11 may be represented in dBm, which is a unit that expresses power in mW on a dB scale.

FIG. 11 may illustrate PAEs and output power Pout for input power Pin according to Q factors in an electronic component (e.g., wireless communication circuit) including a typical capacitor. It may be identified that in the electronic component (e.g., wireless communication circuit) including the typical capacitor, as the Q factor is larger, the PAE and the output power Pout are also higher, and as the Q factor is smaller, the PAE and the output power Pout are also lower. For example, referring to FIG. 11, it may be identified that when the Q factor has an ideal value (e.g., infinity), the PAE for an input power Pin of 10 dBm is approximately 45%. When the Q factor is 30, the PAE for the input power Pin of 10 dBm is approximately 37%, when the Q factor is 20, the PAE for the input power Pin of 10 dBm is approximately 35%, and when the Q factor is 10, the PAE for the input power Pin of 10 dBm is approximately is less than 30%, approximately 28%. In another example, it may be identified in FIG. 11, as the input power Pin increases, the output power Pout monotonously increases, and when the Q factor has an ideal value (e.g., infinity), the output power Pout for the input power Pin of 10 dBm is approximately 26 dBm. It may be identified that when the Q factor is 30, the output power Pout for the input power Pin of 10 dBm is approximately 25 dBm, when the Q factor is 20, the output power Pout for the input power Pin of 10 dBm is approximately 24 dBm, and when the Q factor is 10, the output power Pout for the input power Pin of 10 dBm is approximately 23 dBm. From the perspective of the input power Pin versus the output power Pout, the output power Pout for a Q factor of 10 may be measured to be approximately 3 dB lower than the output power Pout for a Q factor having an ideal value (e.g., infinity). In an electronic component (wireless communication circuit) including a capacitor, when a certain input power Pin is given, the output power Pout may be output as less than 50% due to loss, and as the Q factor decreases, the loss may increase and thus lower power may be output. For example, for the same input power Pin, the output value for the Q factor of 10 may be less than the output value for the Q factor having the ideal value (e.g., infinity) by twice or more. From the graph of FIG. 11, it may be identified how important it is to have a high Q factor in an electronic component (wireless communication circuit) including a capacitor.

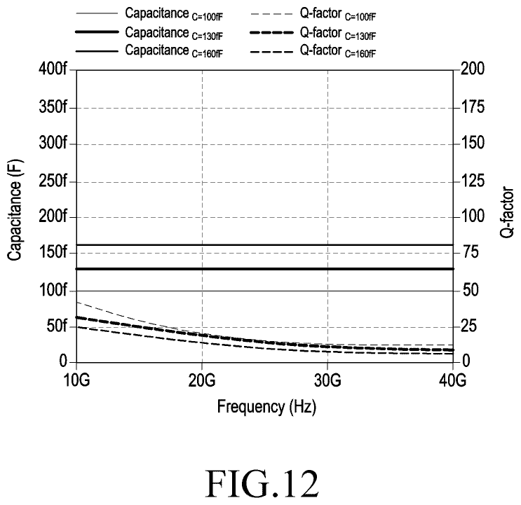

FIG. 12 is a graph illustrating Q factors according to various frequency bands of an electronic component including a capacitor. The graph of FIG. 12 illustrates Q factors corresponding to various capacitances of the capacitor. Herein, the electronic component is for radio frequency (RF) communication, and as millimeter waves (mmWave) are supported, the electronic component may cover a frequency band of several GHz, tens of GHz, or hundreds of GHz.

For example, it may be identified that electronic components including capacitors having capacitances of 100 femto Farads (C=100 fF), 130 femto Farads (C=130 fF), and 150 femto Farads (Farad C=150 fF) have a Q factor of approximately 50 or less in a frequency range of 10 GHz to 40 GHz. In addition, it may be identified as the frequency increases from 10 GHz to 40 GHZ, the electronic components including the capacitors having the capacitances of 100 femto Farads (C=100 fF), 130 femto Farads (C=130 fF), and 150 femto Farads (Farad C=150 fF) have a decreasing Q factor.

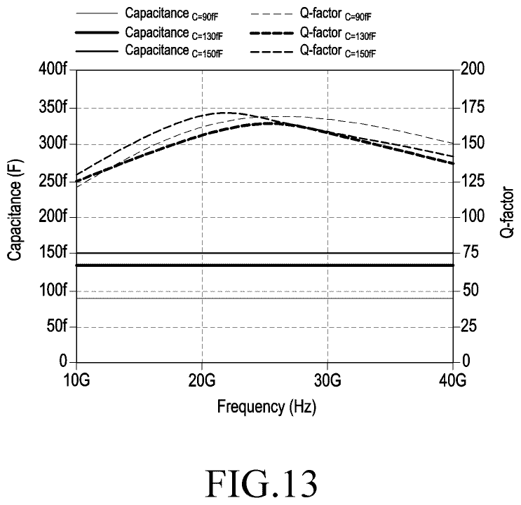

FIG. 13 is a graph illustrating Q factors according to various frequency bands of an electronic component including a coupler according to an embodiment. The graph of FIG. 13 illustrates Q factors corresponding to various capacitances of the coupler.

For example, it may be identified that electronic components including couplers having capacitances of 90 femto Farads (C=90 fF), 130 femto Farads (C=130 fF), and 150 femto Farads (C=150 fF) have a Q factor of approximately 125 or more in the frequency range of 10 GHz to 40 GHz. Further, it may be identified that in the electronic components including the couplers having the capacitances of 90 femto Farads (C=90 fF), 130 femto Farads (C=130 fF), and 150 femto Farads (C=150 fF), the Q factor increases as the frequency increases from 10 GHz to 40 GHz, and then decreases again at some point (e.g., at some point in the range of 20 GHz to 30 GHz), and nonetheless, the Q factor exceeds at least 125.

The disclosure relates to a coupler having the graph characteristics of FIG. 13 and an electronic component including the same, which may be identified as having a much higher Q factor than in FIG. 12. In addition, referring to FIGS. 11 and 13 together, it may be seen that the electronic device of the disclosure includes a coupler having performance similar to that of an ideal element in a millimeter wave environment.

According to an embodiment of the disclosure, the coupler 200 may include the first layer 210 including a plurality of first conductive segments 211, 212, and 213, the second layer 220 arranged to overlap at least partially on the first layer and including the plurality of second conductive segments 221, 222, and 223 line-symmetrical with the plurality of first conductive segments, when the second layer is projected onto the first layer, and the third layer 230 including the plurality of third conductive segments 231 and 232 which are arranged to overlap two different second conductive segments among the plurality of second conductive segments arranged on the second layer.

According to an embodiment, the first layer 210 may include the first portion 211a having a shape elongated along a first direction, the second portion 211b branched from the first portion 211a and having a shape elongated along the first direction, the third portion 212 disposed between the first portion 211a and the second portion 211b and having a shape elongated along the first direction, and the fourth portion 213 disposed spaced apart from the second portion and having a shape elongated along the first direction.

According to an embodiment, the second layer 220 may include the fifth portion 221a having a shape elongated along a first direction, the sixth portion 221b branched from the fifth portion 221a and having a shape elongated along the first direction, the seventh portion 222 disposed between the fifth portion 221a and the sixth portion 221b and having a shape elongated along the first direction, and the eighth portion 223 disposed spaced apart from the second portion and having a shape elongated along the first direction.

According to an embodiment, the first portion 211a of the first layer 210 may overlap the eighth portion 223 of the second layer 220, the second portion 211b of the first layer 210 may overlap the seventh portion 222 of the second layer 220, the third portion 212 of the first layer 210 may overlap the sixth portion 221b of the second layer 220, and the fourth portion 213 of the first layer 210 may overlap the fifth portion 221a of the second layer 220.

According to an embodiment, the plurality of first conductive segments 211, 212, and 213 of the first layer 210 and the plurality of second conductive segments 221, 222, and 223 of the second layer may be connected through a plurality of first conductive vias v1.

According to an embodiment, the plurality of third conductive segments 231 and 232 of the third layer 230 include ninth portions 2311a, 2312a, 2321a, and 2322a extending in a second direction perpendicular to the first direction and tenth portions 2311b, 2312b, 2321b, and 2322b extending in the first direction.

According to an embodiment, the plurality of second conductive segments 221, 222, and 223 of the second layer 220 may be connected to the plurality of third conductive segments 231, 232 of the third layer via a plurality of second conductive vias v2.

According to an embodiment, the plurality of third conductive segments 231, 232 of the third layer 230 may be formed to have an approximately “L” shape.

According to an embodiment, the coupler may further include the fourth layer 240 including the plurality of fourth conductive segments 241, 242, 243, and 244 arranged to at least partially overlap the plurality of third conductive segments 231 and 232 of the third layer 230.

According to an embodiment, the plurality of fourth conductive segments 241, 242, 243, and 244 of the fourth layer 240 may overlap at least two third conductive segments among the plurality of third conductive segments 231 and 232.

According to an embodiment, the plurality of third conductive segments 231 and 232 of the third layer 230 and the plurality of fourth conductive segments 241, 242, 243, and 244 of the fourth layer may be connected through a plurality of third conductive vias v3.

According to an embodiment, a dielectric may be disposed between the first layer 210 and the second layer 220, and between the second layer 220 and the third layer 230.

According to an embodiment, the coupler may be formed in a form of an integrated circuit included on a semiconductor wafer, and the coupler may be formed by being integrated on a die formed on the semiconductor wafer.

According to an embodiment, the coupler may be electrically connected to a first ground disposed on a rear surface of the die, and at least partially surrounded by a second ground disposed on a top surface of the die.

According to an embodiment, the coupler may further include a metal member disposed on the top surface of the die.

According to an embodiment of the disclosure, the coupler 200 may be provided, which includes the plurality of first conductive segments 211, 212, and 213, the plurality of second conductive segments 221, 222, and 223 arranged to at least partially overlap the plurality of first conductive segments, the first conductive via v1 connecting the plurality of first conductive segments and the plurality of second conductive segments, the plurality of third conductive segments 231, and 232 arranged to overlap two different second conductive segments among the plurality of second conductive segments, the second conductive via v2 connecting the plurality of second conductive segments and the plurality of third conductive segments, the plurality of fourth conductive segments 241, 242, 243, and 244 arranged to at least partially overlap the plurality of third conductive segments, and the third conductive via v3 connecting the plurality of third conductive segments and the plurality of fourth conductive segments.

According to an embodiment, the plurality of first conductive segments, the plurality of second conductive segments, and the first conductive via may be line-symmetrical with respect to an imaginary line penetrating the coupler in a first direction.

According to an embodiment, the first conductive segment may include the first portion 211a elongated along the first direction, the second portion 211b branched from the first portion 211a and elongated along the first direction, the third portion 212 disposed between the first portion 211a and the second portion 211b and elongated along the first direction, and the fourth portion 213 disposed spaced apart from the second portion and elongated along the first direction, and the second conductive segment may include the fifth portion 221a elongated along the first direction, the sixth portion 221b branched from the fifth portion 221a and elongated along the first direction, the seventh portion 222 disposed between the fifth portion 221a and the sixth portion 221b and having a shape elongated along the first direction, and the eighth portion 223 disposed spaced apart from the second portion and having a shape elongated along the first direction.

According to an embodiment, the first portion 211a of the first conductive segment may overlap the eighth portion 223 of the second conductive segment, the second portion 211b of the first conductive segment may overlap the seventh portion 222 of the second conductive segment, the third portion 212 of the first conductive segment may overlap the sixth portion 221b of the second conductive segment, and the fourth portion 213 of the first conductive segment may overlap the fifth portion 221a of the second conductive segment.

According to an embodiment, the third conductive segment may include the ninth portions 2311a, 2312a, 2321a, and 2322a extending in a second direction perpendicular to the first direction and the tenth portions 2311b, 2312b, 2321b, and 2322b extending in the first direction, and may be formed to have an approximately “L” shape.

According to an embodiment, the fourth conductive segment may include the eleventh portions 241 and 243 and the twelfth portions 242 and 244, which extend in the first direction.

According to the disclosure, the coupler 200 according to the above-described embodiments may be provided in the form illustrated in FIG. 2 or the form of the coupler module 100 illustrated in FIG. 1. As mentioned above, the components and/or specific shape of the coupler module 100 may vary depending on an embodiment.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A coupler comprising:
a first layer including a plurality of first conductive segments;
a second layer arranged to overlap at least partially the first layer and including a plurality of second conductive segments line-symmetrical with the plurality of first conductive segments, when the second layer is projected onto the first layer; and
a third layer including a plurality of third conductive segments which are arranged to overlap two different second conductive segments among the plurality of second conductive segments arranged on the second layer.

2. The coupler of claim 1, wherein the first layer includes a first portion having a shape elongated along a first direction, a second portion branched from the first portion and having a shape elongated along the first direction, a third portion disposed between the first portion and the second portion and having a shape elongated along the first direction, and a fourth portion disposed spaced apart from the second portion and having a shape elongated along the first direction.

3. The coupler of claim 1, wherein the second layer includes a fifth portion having a shape elongated along a first direction, a sixth portion branched from the fifth portion and having a shape elongated along the first direction, a seventh portion disposed between the fifth portion and the sixth portion and having a shape elongated along the first direction, and an eighth portion disposed spaced apart from the second portion and having a shape elongated along the first direction.

4. The coupler of claim 3, wherein the first portion of the first layer overlaps the eighth portion of the second layer, the second portion of the first layer overlaps the seventh portion of the second layer, the third portion of the first layer overlaps the sixth portion of the second layer, and the fourth portion of the first layer overlaps the fifth portion of the second layer.

5. The coupler of claim 4, wherein the plurality of first conductive segments of the first layer and the plurality of second conductive segments of the second layer are connected through a plurality of first conductive vias.

6. The coupler of claim 1, wherein the plurality of third conductive segments of the third layer include a ninth portion extending in a second direction perpendicular to the first direction and a tenth portion extending in the first direction.

7. The coupler of claim 1, wherein the plurality of second conductive segments of the second layer are connected to the plurality of third conductive segments of the third layer via a plurality of second conductive vias.

8. The coupler of claim 1, wherein the plurality of third conductive segments of the third layer are formed to have an approximately “L” shape.

9. The coupler of claim 1, further comprising a fourth layer including a plurality of fourth conductive segments arranged to at least partially overlap the plurality of third conductive segments of the third layer.

10. The coupler of claim 9, wherein the plurality of fourth conductive segments of the fourth layer overlap at least two third conductive segments among the plurality of third conductive segments.

11. The coupler of claim 9, wherein the plurality of third conductive segments of the third layer and the plurality of fourth conductive segments of the fourth layer are connected through a plurality of third conductive vias.

12. The coupler of claim 1, wherein a dielectric is disposed between the first layer and the second layer, and between the second layer and the third layer.

13. The coupler of claim 1, wherein the coupler comprises an integrated circuit included on a semiconductor wafer, and
wherein the coupler is integrated on a die formed on the semiconductor wafer.

14. The coupler of claim 13, wherein the coupler is electrically connected to a first ground disposed on a rear surface of the die, and
wherein the coupler is at least partially surrounded by a second ground disposed on a top surface of the die.

15. The coupler of claim 13, further comprising a metal member comprising a metal disposed on a top surface of the die.

16. A coupler comprising:
a plurality of first conductive segments,
a plurality of second conductive segments arranged to at least partially overlap the plurality of first conductive segments,
a first conductive via connecting the plurality of first conductive segments and the plurality of second conductive segments,
a plurality of third conductive segments arranged to overlap two different second conductive segments among the plurality of second conductive segments,
a second conductive via connecting the plurality of second conductive segments and the plurality of third conductive segments,
a plurality of fourth conductive segments arranged to at least partially overlap the plurality of third conductive segments, and
a third conductive via connecting the plurality of third conductive segments and the plurality of fourth conductive segments.

17. The coupler of claim 16, wherein the plurality of first conductive segments, the plurality of second conductive segments, and the first conductive via are line-symmetrical with respect to an imaginary line penetrating the coupler in a first direction.

18. The coupler of claim 16, wherein the first conductive segment includes the first portion elongated along the first direction, the second portion branched from the first portion and elongated along the first direction, the third portion disposed between the first portion and the second portion and elongated along the first direction, and the fourth portion disposed spaced apart from the second portion and elongated along the first direction, and
wherein the second conductive segment includes the fifth portion elongated along the first direction, the sixth portion branched from the fifth portion and elongated along the first direction, the seventh portion disposed between the fifth portion and the sixth portion and having a shape elongated along the first direction, and the eighth portion disposed spaced apart from the second portion and having a shape elongated along the first direction.

19. The coupler of claim 16, wherein the first portion of the first conductive segment overlaps the eighth portion of the second conductive segment, wherein the second portion of the first conductive segment overlaps the seventh portion of the second conductive segment, wherein the third portion of the first conductive segment overlaps the sixth portion of the second conductive segment, and the fourth portion of the first conductive segment overlaps the fifth portion of the second conductive segment.

20. The coupler of claim 16, wherein the third conductive segment includes the ninth portions extending in a second direction perpendicular to the first direction and the tenth portions extending in the first direction, and is formed to have an approximately “L” shape.
